(19) United States
(12) Patent Application Publication
(10) Pub. No.: US 2014/0288704 A1
(43) Pub. Date: Sep. 25, 2014

(54) System and Method for Controlling Behavior of a Robotic Character

(71) Applicant: HANSON ROBOKIND AND INTELLIGENT BOTS, LLC, Dallas, TX (US)

(72) Inventors: Stuart Baurmann, Austin, TX (US); Matthew Stevenson, Dallas, TX (US)

(73) Assignee: HANSON ROBOKIND AND INTELLIGENT BOTS, LLC, Dallas, TX (US)

(21) Appl. No.: 14/214,577

(22) Filed: Mar. 14, 2014

Related U.S. Application Data
(60) Provisional application No. 61/784,839, filed on Mar. 14, 2013.

(51) Int. Cl. B25J 9/00

(52) U.S. Cl. CPC B25J 9/0003
USPC 700/245

(57) ABSTRACT

The present invention provides a system for controlling the behavior of a social robotic character. The system comprises a scene planner module. The scene planner module is configured to assemble a scene specification record comprising one or more behavior records. A scene execution module is configured to receive the scene specification record and to process the scene specification record to generate an output. A character interaction module is configured to receive the output and from the output cause the social robotic character to perform one or more behaviors specified by the one or more behavior records. The social robotic character may be embodied as a physical robot or a virtual robot.

### CROSS-REFERENCE

The present application claims the benefit of U.S. Provisional Application No. 61/784,839, titled “System and Method for Robotic Behavior,” filed on Mar. 14, 2013, which is hereby incorporated by reference in its entirety.

### TECHNICAL FIELD

The invention relates generally to a system and method for controlling the behavior of a social robotic character, which may be embodied as a physical or virtual character.

### BACKGROUND

Characters (i.e., robotic and virtual/animated characters) are becoming capable of interacting with people in an increasingly life-like manner. The term character as used herein refers to a social robotic character, which may be embodied as a physical or virtual character. Characters are especially well-suited for carrying out discrete, purposeful tasks or exercises. An example of such a task would be for a character to teach an autistic student how to politely thank people for gifts. However, to carry out such tasks in a life-like manner, the character must monitor and adapt to each human user's unpredictable behavior while continuing to perform the tasks at hand. As such, developing life-like programs or applications for a character is exceedingly complex and difficult. In particular, it is difficult for the character to perform in an apparently coherent and responsive fashion in the face of multiple simultaneous goals, perceptions, and user inputs.

Furthermore, if these applications are executed solely using locally available hardware and software, then they would require complex software and expensive computer hardware to be installed locally. The locally available hardware and software is referred to as the local agent. Meanwhile, modern computer networks have made it possible to access very powerful processors in centralized server locations (“the cloud”) at much lower cost per computational operation than on a local agent. These central servers, or remote agent, offer throughput and cost advantages over local systems, but can only be accessed over the network relatively infrequently (compared to local resource accesses), with significant time latency, and subject to common network reliability and performance concerns. Using a distributed network computing approach can exacerbate the problem of maintaining coherence and responsiveness in the character's performance as discussed in the previous paragraph.

Thus, there is a need for a system for efficiently developing programs and/or applications for a character to perform discrete, purposeful tasks or exercises, including where such tasks require the character to coherently perform many functions sequentially as well as simultaneously. Further, there is a need for such a system to account for and adapt to the environment in which the character is operating. Still further, there is a need for a system executing such programs and/or applications to operate efficiently and be implementable using low-cost hardware at the local-agent level. Thus, there is a need for a system that offloads computationally difficult tasks to a remote system, while taking into account the latency, reliability, and coherence issues inherent in network communication among distributed systems.

### SUMMARY

The present invention provides a system for controlling the behavior of a social robotic character. The system comprises a scene planner module. The scene planner module is configured to assemble a scene specification record comprising one or more behavior records. A scene execution module is configured to receive the scene specification record and to process the scene specification record to generate an output. A character interaction module is configured to receive the output and from the output cause the social robotic character to perform one or more behaviors specified by the one or more behavior records. The social robotic character may be embodied as a physical robot or a virtual robot.

The present invention provides a method for controlling the behavior of a social robotic character. The method comprises the step of assembling a scene specification record comprising one or more behavior records. Then, the scene specification record is processed and an output is generated. Finally, the output then causes the social robotic character to perform one or more behaviors specified by the one or more behavior records.

The present invention also provides a non-transitory computer readable storage medium having stored thereon machine readable instructions for controlling the behavior of a social robotic character. The non-transitory computer readable storage medium comprises instructions for assembling a scene specification record comprising one or more behavior records. The non-transitory computer readable storage medium further comprises instructions for processing the scene specification record to generate an output, as well as instructions for causing the social robotic character to perform one or more behaviors specified by the one or more behavior records based on the output.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram illustrating a preferred system for controlling behavior of a social robotic character in accordance with the present invention;

FIG. 2 is a schematic diagram of higher-layer functions of the preferred system;

FIG. 3 is a schematic diagram of middle-layer functions of the preferred system;

FIG. 4 is a flow chart illustrating an exemplary method used in the preferred system;

FIG. 5 is a flow chart more particularly illustrating an exemplary method for performing the step processing behaviors of the exemplary method of FIG. 4;

FIG. 6 is a flow chart more particularly illustrating an exemplary method for performing the step of processing a single behavior of FIG. 5;

FIG. 7 is a schematic diagram of lower-layer functions of the preferred system; and

FIG. 8 is a diagram of a preferred embodiment of the present invention illustrative in a real-world scenario.

### DETAILED DESCRIPTION

Refer now to the drawings wherein depicted elements are, for the sake of clarity, not necessarily shown to scale and wherein like or similar elements are designated by the same reference numeral through the several views. In the interest of conciseness, well-known elements may be illustrated in schematic or block diagram form in order not to obscure the present invention in unnecessary detail, and details concerning various other components known to the art, such as computers, electronic processors, and the like necessary for the operation of many electrical devices, have not been shown or discussed in detail inasmuch as such details are not considered necessary to obtain a complete understanding of the present invention, and are considered to be within the skills of persons of ordinary skill in the relevant art. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

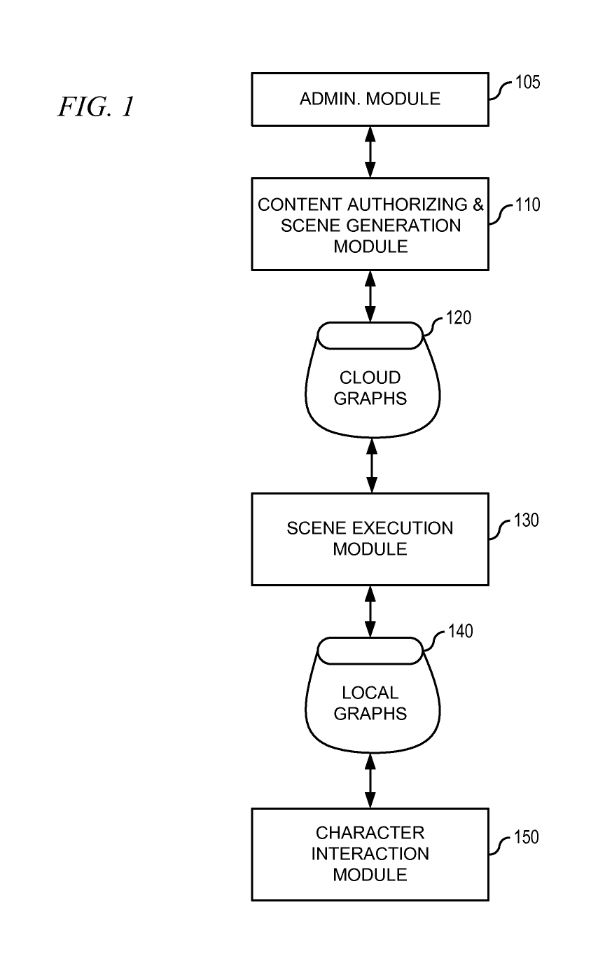

Referring to FIG. 1, a context process diagram illustrating a preferred system 100 for controlling behavior of a character in accordance with the present invention is provided. The system 100 comprises an administrative module 105, which may receive input from a user interface (UI) or artificial intelligence (AI) engine, to select or load a scene. A scene is a coherent set of intentional activities for the character to perform. More particularly, a scene is defined as a set of one or more behaviors for the character to perform simultaneously (or nearly simultaneously). A behavior is defined as a set of one or more steps or actions that the character may conditionally perform to carry out the desired task or exercise. In other words, a set of potentially concurrent or sequential tasks or exercises for the character to perform. A typical scene lasts ten to one hundred seconds, but may be longer or shorter. A scene may often contain multiple behavior intentions related to independent motivations; for example, a scene may include a primary behavior of delivering a performance of human-authored content, such as a story, performance, lesson exercise, or game played with the users. Secondly, the same scene may also include a behavior to address input recently perceived by the character that is not related to the first ongoing performance, for example, the character desiring to greet a new user who just entered the room. Thirdly, the same scene may also include a behavior generated by an internal motivation of the character, e.g., including practical needs such as battery charging, system updates, or diagnostics. Fourthly, the same scene might include an ongoing response to some external stimulus, such as, a song playing in the room to which the character dances or taps his toe (in a way coordinated or independent from the first content performance task). Fifthly, the scene may include behavioral provisions for some important but unlikely short term interactive scenarios that could arise quickly, such as those involving emotional or practical support for users known to be at risk for distress, such as users diagnosed with dementia or autism. These are merely examples for various types of behaviors that may be accounted for in a scene and a scene may encompass many other types of diverse behavior that the character is capable of performing.

A content authoring and scene generator module (CASGM) 110 is responsible for generating the scene, which is more specifically referred to as the scene specification record. The CASGM 110 accesses various cloud graphs 120, which contain the data necessary to determine the motivations of the character and provides an output comprising a scene to certain cloud graphs 120. The CASGM 110 and the cloud graphs comprise the higher-layer functions of the system 100 and are preferably implemented using remote hardware and software or in the “cloud,” i.e., at a remote agent. In alternative embodiments, the higher-layer functions may be implemented on a local agent. In yet other embodiments, the local agent has a less powerful version of the higher-layer functions that may be used if communication with the remote system fails. A scene execution module (SEM) 130 accesses certain information in the cloud graphs 120, including the scene specification record. It processes the behaviors in the scene by accessing various local graphs 140 and provides an output to various local graphs 140 and also the cloud graphs 120. The SEM 130 and certain local graphs 140 comprise the middle-layer functions of the system 100 and are implemented on a local agent. Preferably, the higher-layer functions when implemented remotely may service a plurality of local agents.

A character interaction module (CIM) 150 accesses information on certain local graphs 140 and may cause the character to perform the desired behavior. Preferably, graphs are implemented in compliance with Resource Description Framework (RDF) standards published by the World Wide Web Consortium (W3C). Alternatively, instead of graphs, other forms for data transfer and storage may be used, including SQL databases, column stores, object caches, and shared file systems.

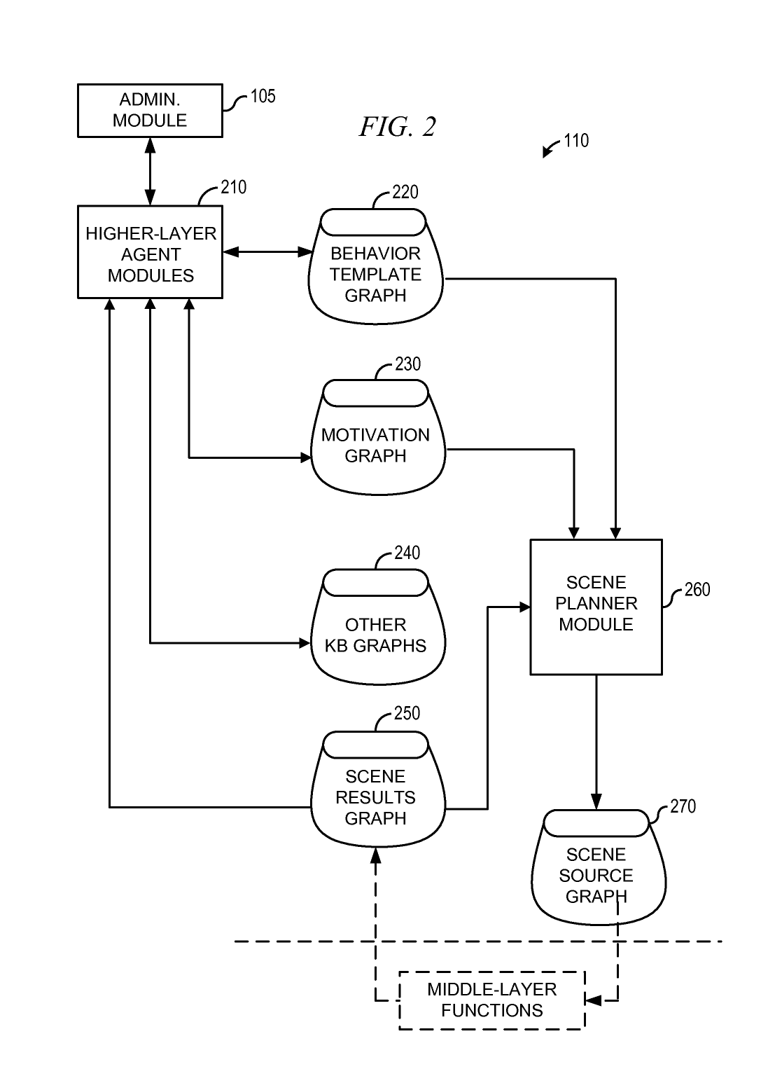

A preferred implementation of the higher-layer functions is shown in FIG. 2. Referring to FIG. 2, the higher-layer functions comprise higher-layer agent modules 210, which receive input from the administrative module 105. The higher-layer agent modules 210 maintain and update various cloud graphs comprising a behavior graph 220, a motivation graph 230, and other knowledge base graphs 240. The behavior template graph 220 is authored and maintained by developers. It in essence is the artificial intelligence or brains for the character. The behavior template graph 220 is preferably a database of permanent content records. The records in behavior template graph 220 are templates, which are partially completed behavior specifications for a variety of general character intentions, e.g., such as telling a story, asking a question, or saying goodbye. The templates in the behavior template graph 220 are authored to provide for a life-like experience for end users. Preferably, the behavior template graph 220 is located remotely and thus may be shared by a plurality of client local agents. The motivation graph 230 represents the current high-level motivations of a particular character. When the high-layer functions are remote, then each character being controlled will have its own motivation graph 230. The other knowledge base graphs 240 provide any other information that may be required by the higher-layer functions. The higher-layer agent modules are responsible for monitoring and updating the graphs, including by using the results of processed scenes which may be accessed via a scene results graph 250. Preferably, there is one scene results graph 250 for each character.

A scene planner module 260 is provided and is responsible for translating current motivations into a scene specification record. The scene planner module 260 first accesses the motivation graph 230 to retrieve the current motivations for a particular character. It also accesses the scene results graph 250 for the character to determine if activity from the previous scene requires further processing. The scene planner module 260 then generates a complete scene specification record by accessing the behavior template graph 200 whose records provide a starting point. The scene specification record is preferably defined by the following pseudo-code:

SceneSpec {

myIdent : Ident
myBehaviorSpecs : Map[Ident,BehaviorSpec]
myChannelSpecs : Map[Ident,ChannelSpec] }

BehaviorSpec {

myIdent : Ident }

StepBehaviorSpec extends BehaviorSpec {

myStepSpecs : Set[StepSpec]}

StepSpec {

myIdent: Ident
myActionSpec: ActionSpec
myGuardSpecs: Set[GuardSpec] }

GuardSpec {

| | |
|---|---|
| myIdent | : Ident |

mySourceChannelSpecs : Set[ChannelSpec]
myPredicateExpressionID : Ident }

ActionSpec {

myIdent : Ident
myTargetChannelSpecs : Set[ChannelSpec]
myOutputExpressionID: Ident }

ChannelSpec {

myIdent : Ident
myTypeID : Ident }

QueryWiredChannelSpec extends ChannelSpec {

myWiringQueryText : String

}

The scene specification record is output to a scene source graph 270, which is then accessed by middle-layer functions to run the scene. The middle-layer functions also provide the results of scenes being run via the scene results graph 250.

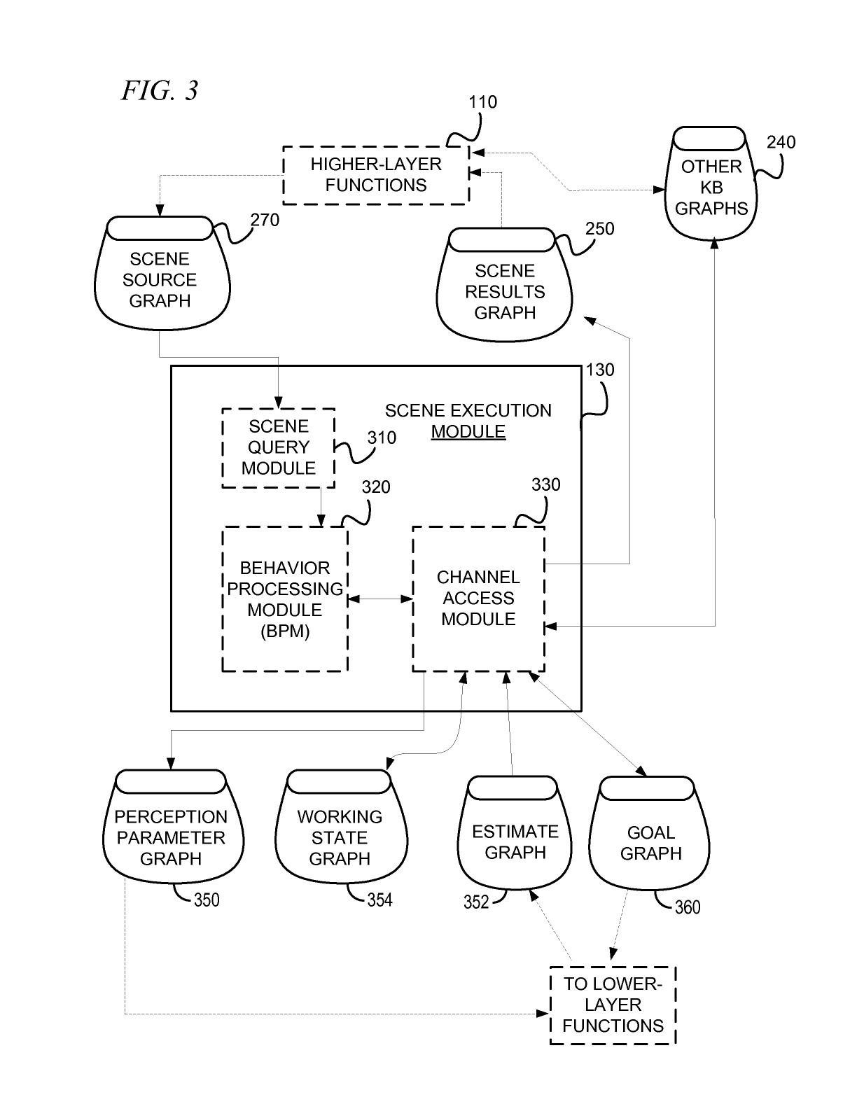

Referring to FIG. 3, a block diagram of the middle-layer functions of system 100 is provided. The middle-layer functions of system 100 comprise the scene execution module (SEM) 130. The SEM 130 comprises a scene query module 310, which accesses the scene source graph 270 to retrieve the scene specification record including all behavior records comprising the scene specification records. Like other graphs, the scene source graph 270 is preferably stored in a local or remote RDF repository. Fetching a scene specification from such a repository may be preferably implemented as shown in the following code written in the Java programming language:

// RepoClient provides access to some set of local+remote graphs
RepoClient aRepoClient =

findRepoClient(“big-database-in-the-sky”);

// Following code is the same regardless of whether the repo is local
or remote.
// Ident is equivalent to a URI - a semi-globally-unique identifier

| | |
|---|---|
| Ident | sceneSourceGraphID; |
| Ident | sceneSpecID; |
| SceneSpec | ss = aRepoClient.fetchSceneSpec(sceneSourceGraphID, |

sceneSpecID);

The scene query module 310 then loads the retrieved scene specification (including all behavior records therein) into memory and control passes to a behavior processing module (BPM) 320.

Prior to the BPM 320 processing the behavior records, a channel access module 330 sets-up or “wires” any necessary graphs to input and output channels that are needed to process the scene. Input channels are wired to readable graphs, which are accessed by the BPM 130 to evaluate guards from the scene's behaviors (discussed below). Output channels are wired to writable graphs, which are accessed by the BPM 130 to accomplish the output steps from the scene's behaviors (discussed below). Preferably, the wired graphs include: a perception parameter graph 350, an estimate graph 352, a goal graph 360, the scene results graph 250, and the other knowledge base graph 240.

After wiring is complete, the BPM 320 begins to process behavior records of the scene specification record in order to determine appropriate output actions for the character to perform. Each behavior record comprises a set of one or more steps. A step is generally an action by the character, or a change in the character's state. Steps that a character may perform include, but are not limited to: outputting speech in the character's voice with lip synchronization; beginning or modifying a walking motion in some direction; establishing eye contact with a user; playing a musical phrase or sound effect; updating a variable stored in some graph including the local working state graph 354 or cloud-hosted scene results graph 250. Each step has zero or more guards associated with it. A guard defines a condition that must be satisfied before the associated step can be performed. A guard is preferably a predicate evaluated over one or more of the graphs that are currently wired. For example, a step instructing the character to say “You're welcome!” may have a guard associated with it that requires a student to first say “Thank you!”, or an equivalent synonym. The example predicate may be written in pseudo-code as follows:

HeardVerbal(resolveChannelToGraph(SPEECH_IN),

SynonymSet(“Thank You”))

To evaluate this example, the BPM 320 would access the SPEECH_IN channel, which would be resolved by the channel access module 230 to the estimate graph 352 containing the results of speech input processing. As the BPM 320 processes the scene (as discussed in more detail below), output related to various steps is provided by writing records into the goal graph 360, which triggers processing by lower-layer functions as discussed below.

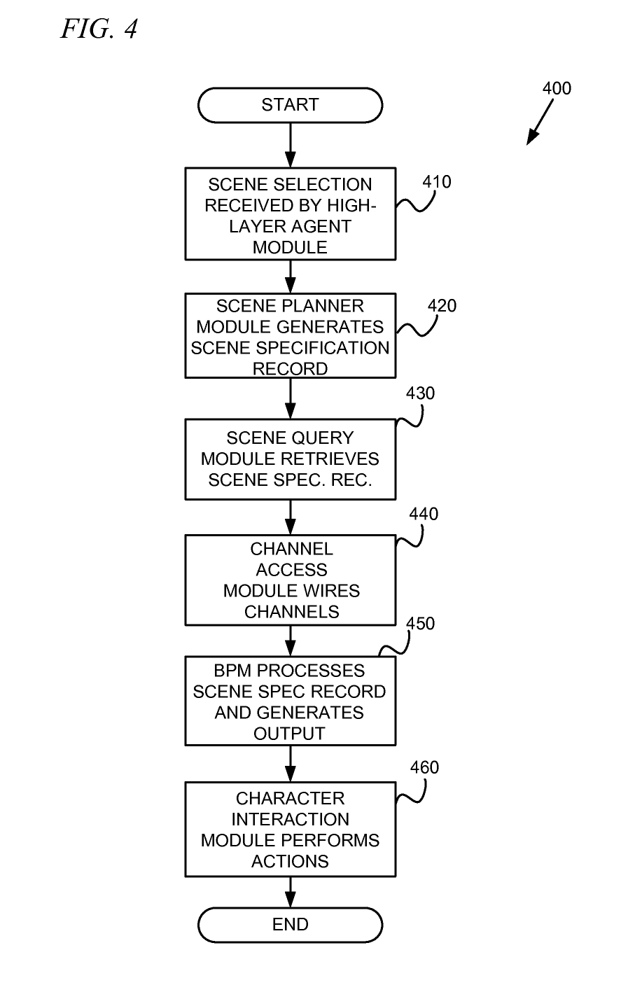

Referring to FIG. 4, a flow chart of a preferred method 400 for implementing controlling behavior of a character is provided. At step 410, the administrative module 105 receives a selection of a scene. For example, using a user interface, a user could tell the character to load a particular scene. In one embodiment of the present invention, a user interface is provided on a tablet computer for providing an input, which is in communication with the local agent of the character. The scene planner module 260 then consults information in the various available graphs and assembles the scene specifications record containing various behavior records, which are then provided to the scene source graph 270 (step 420). The scene query module 310 then queries scene source graph 270 to retrieve the scene specification (step 430). The channel access module 330 then determines which graphs are necessary for evaluating the behavior records in the scene specification record and wires those graphs to channels (step 440). Once wired, the wired graph continues to be available for reading and writing from the SEM 130. Meanwhile, other system components outside of SEM 130 may also be connected to the same graphs, allowing for general communication between SEM 130 and any other system component. The BPM 320 processes the behaviors simultaneously (or near simultaneously) as discussed in more detail below (step 450). While the BPM 320 is processing the scene, the BPM may send output records (if any is permitted at that given moment) to lower-layer systems in character interaction module 150, which then may cause the character to perform the desired behavior (step 460). Steps 450 and 460 are performed simultaneously and explained in more detail below. The BPM 320 stops processing after all behavior records are processed completely. The BPM 320 may also stop processing if interrupted by the administrative module 105. Control returns to the administrative module 105, which may then load a new scene.

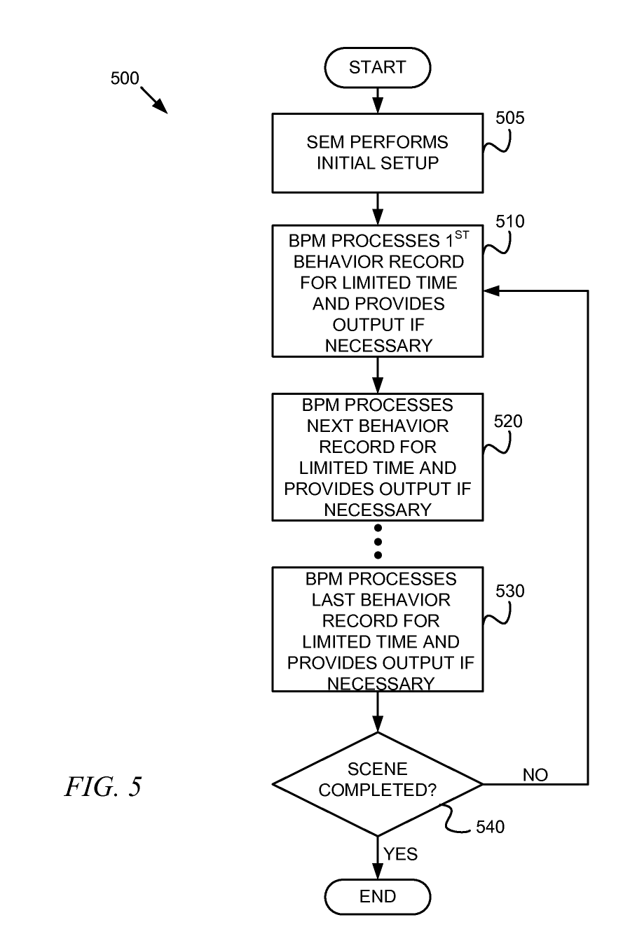

Referring to FIG. 5, a preferred method 500 of processing the behavior records of the scene specification record (e.g., step 450) is disclosed. Prior to processing, the SEM 130 performs initial setup (step 505). This step creates and stores an active queue for each behavior record containing all the possible steps for that behavior record. The BPM 320 selects a first behavior record from the scene specification record in order that they are provided in the scene specification record. Alternatively, the selection may be made at random or by an order specified within the scene specification record. The BPM processes the first selected behavior for a limited duration of time, and any steps that are permitted by their guards are output by writing records into the goal graph 360 (step 510), which triggers processing by lower-layer functions as discussed below. Steps may also write output into the working state graph 354, the perception parameters graph 350, the scene results graph 250, or the other knowledge-base graphs 240. Preferably, each behavior record is processed for less than 10 milliseconds, but could be more or less. The BPM then selects the next behavior record and processes it for a limited time and generates output (if any) (step 520). The BPM similarly sequentially processes each of the remaining behavior records each for a limited time (step 530). The total amount of time required to process all behavior records once through is preferably less than 200 milliseconds, which is achievable for most scenes using low-cost hardware available at the local agent. This provides for an overall refresh rate of 5 HZ. After each of the behavior records has been processed for a limited time, the BPM determines if the scene has been completed (step 540). A typical scene may last for ten to one hundred seconds, and thus will typically require many iterations through the complete set of behavior records. If the scene is not yet completed, the BPM returns to the first behavior record and processes it further for a limited time (step 510). Similarly, the remaining behavior records are processed (steps 520 and 530). After a sufficient number of passes, all behavior records will be processed fully (e.g., have no remaining possible steps to output) and the scene will be complete, at which point processing terminates and the BPM returns control to the higher-layer systems. Alternatively, a scene may be terminated by the administrative module 105 or other means, for example, scenes may automatically terminate after a predetermined amount of time (such as, 90 seconds). As such, the BPM 320 can preferably be implemented efficiently and reliably as a single-threaded, deterministic system using an inexpensive microprocessor and avoiding complex concerns regarding shared state that arise from preemptive multi-threading. Yet, the approximately 5 HZ (200 millisecond cycle) refresh rate for processing of the concurrent behavior set is sufficient for the BPM to apparently process all behaviors simultaneously (from the view point of a human user), thus providing a responsive and life-like interactive experience.

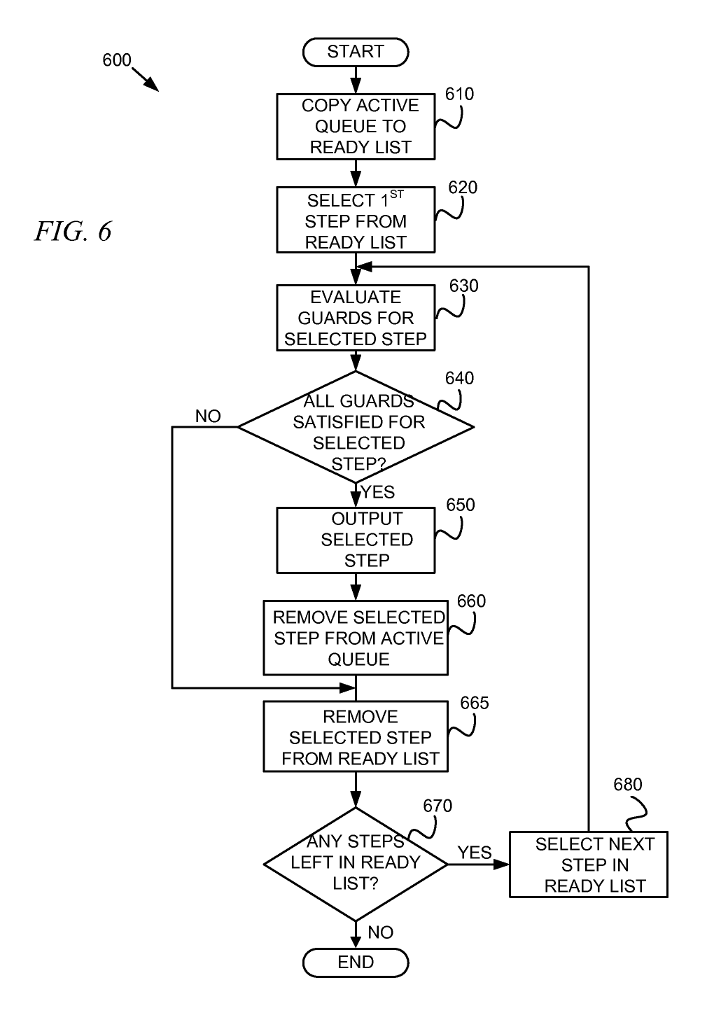

Referring to FIG. 6, an exemplary method 600 for the step of processing a particular behavior record (e.g., step 510) is described in more detail. Prior to beginning processing, the BPM 320 creates an active queue containing all the steps in the behavior record (step 505). At step 610, the BPM copies the active queue to a ready list. The BPM then selects the first step (step 620) based on the order in which the steps are stored in the behavior record. Alternatively, steps may be selected at random or in an order specified in the behavior record. The BPM evaluates any guards associated with the selected step by querying the state of relevant graphs to which the channels are wired (step 630). The BPM then determines if all the guards for the selected step are satisfied (step 640). If all the guards associated with the selected step are satisfied, then the selected step is output by writing records to the goal graph 360 (step 650). Once the selected step is output, it is removed from the active queue (step 660). Regardless of whether the step was output, the step is removed from the ready list (step 665). Then, the BPM checks if any steps remain in the ready list (step 670). If there are, the next step is selected (step 680), and it is processed similarly starting at step 630. Once a single iteration through the ready list is complete, the BPM moves on to the next behavior record and processes it similarly (see FIG. 5).

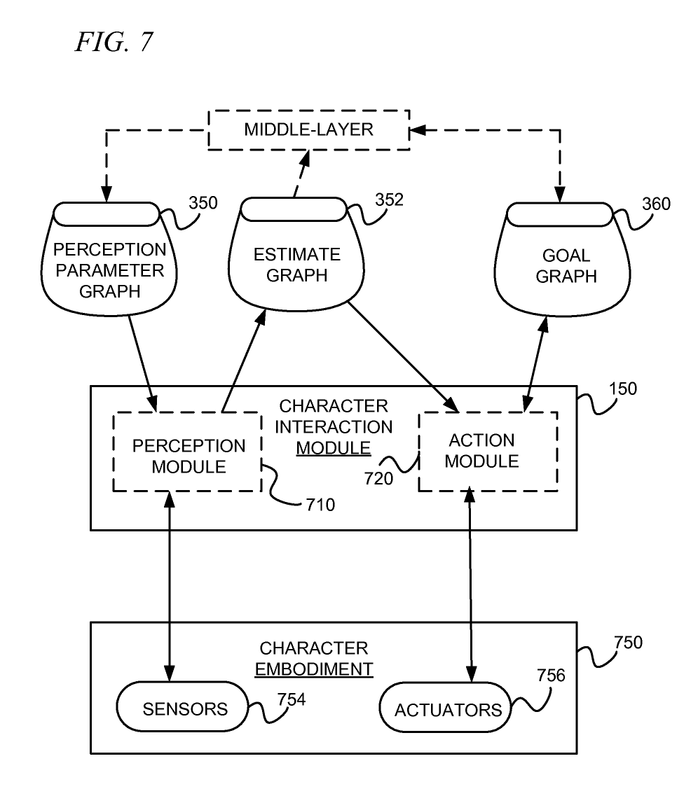

Referring to FIG. 7, the lower layer of the system 100 is described by a schematic diagram. The lower layer of the system 100 comprises the character interaction module 150. The character interaction module 150 is persistently connected to the local graphs, e.g.: the perception parameter graph 350, the estimate graph 352, the goal graph 360, and various other graphs that are needed. Preferably, all information graphs used by the lower layer are local graphs which may be accessed with low latency. This constraint allows that the lower-layer components can execute many refreshes per second (generally 10 HZ or higher) of all perception and action components, which allows for the accurate perception of input and smooth performance of output. However, remote or cloud graphs may also be used, in particular for perceptions and action where latency is not a problem.

The lower layer also comprises a character embodiment 750. The character is preferably embodied as a physical character (e.g., a robot). Alternatively, the character may be embodied in a virtual character. In either embodiment, the character may interact in the physical world with one or more human end users. A physical character embodiment may directly interact with the user, while a virtual character embodiment (also referred to as an avatar) may be displayed on the screen of one or more tablets, computers, phones, or the like and thus interact with the users. The character embodiment 750 contains sensors 754 for receiving input. For example, sensors 754 may include: cameras, microphones, proximity sensors, accelerometers, gyroscopes, touchscreens, keyboard and mouse, and GPS receivers. The character embodiment 754 also contains actuators 756 for providing output and interacting with the user. For example, actuators may include: servo motor mechanisms for physical movements (e.g., waving a hand or walking), speakers, lights, display screens, and other kinds of audiovisual output mechanisms. In the case of a virtual character embodiment, the body joints of the virtual character or avatar represent virtual servos and are controlled through a process analogous to that used with a physical robot character. Furthermore, in the virtual case, it is preferred to make use of sensors and actuators attached to or embedded in the computer, tablet, or phone on which the virtual avatar is displayed.

Information provided by sensors 754 is continually processed by a perception module 710. Parameters of the perception process are maintained in the perception parameter graph 350. Results of the perception process are intermittently posted into the estimate graph 352. For example, the perception module 710 monitors input from a microphone sensor and may determine that some sound heard on the microphone contains the words “Hello there, nice robot.” If monitoring for that phrase, the perception module 710 would then post a corresponding estimated result into the estimate graph 352, which may be used by another component, such as the BPM to evaluate a guard and trigger a step to be performed. In another example, the perception module 710 may determine that an image from a camera sensor contains a familiar looking human face and calculate an estimate of that person's identity and location, which is posted into the estimate graph 352 for use by the BPM 320 and other interested components.

Goals for actions of the character are set by middle-layer components as discussed above through the goal graph 360. An action module 720 monitors these goals and sends appropriate commands to the appropriate actuators 756 to cause the character to perform the action or goal. For example, a step executed by the BPM may configure a speech-output goal to say a particular piece of speech text along with synchronized mouth movements commands sent to the character's body. Other goals may include, e.g., to play a particular musical score, to walk in a particular direction, or to make eye contact with a particular user. The action module 720 records progress towards the completion of each goal by sending goal progress update records into the goal graph 360. These records are then available for reading by middle and higher layer functions. In some cases, such as maintaining eye contact with a user, the action module 720 may need to process frequently updated sensor information in a closed feedback control loop. The action module 720 may do this by directly accessing the estimate graph 352.

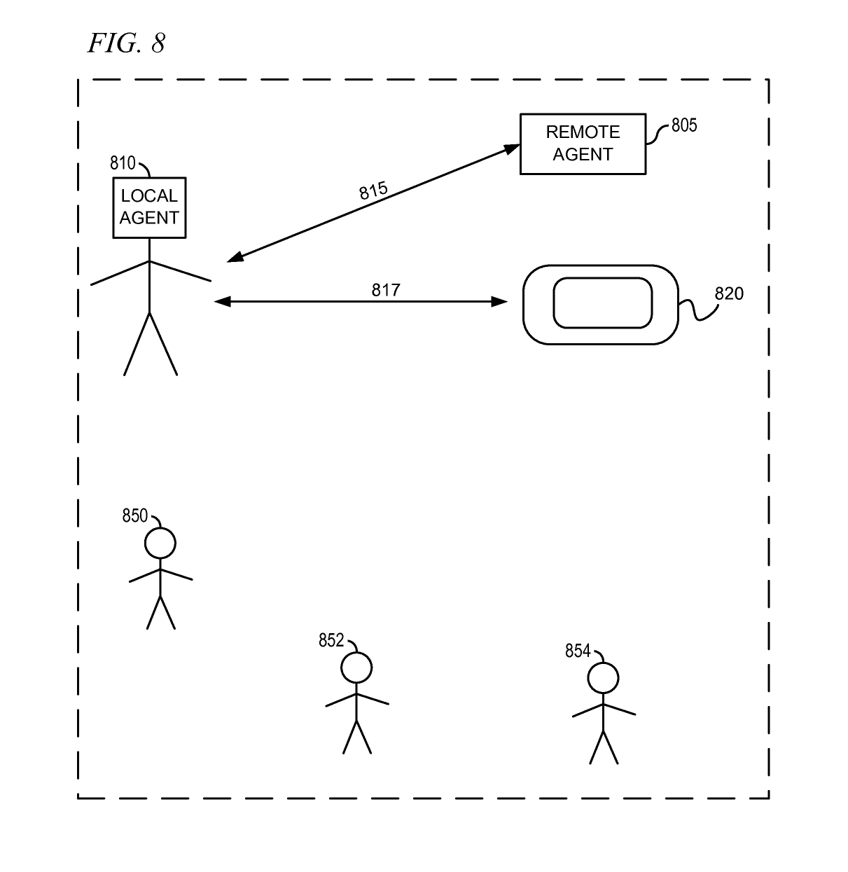

We now consider a detailed example illustrating a preferred embodiment of the present invention with reference to FIG. 8. This embodiment comprises a local agent 810. The local agent 810 in this embodiment is a physical character named Zig. Alternatively, Zig may be a virtual character. Zig comprises the necessary hardware and software to perform all the lower and middle layer functions described herein. The embodiment further comprises a remote agent 805, i.e., cloud-based servers, for performing all the high-layer functions described herein. Zig is in communication with the remote agent 805 via a communication interface 815, preferably a wireless connection to the Internet. Zig is also in communication with an administrative agent 820 via communication interface 817, preferably a wireless connection. The administrative agent 820 is being operated by a teacher named Tammy (not shown). In alternate embodiments, the role of Tammy may be performed instead by a high-level artificial intelligence (AI) component that would be responsible for choosing appropriate scenes.

Using an administrative interface provided by the administrative agent, Tammy may control certain behaviors of Zig, e.g., by causing him to play a scene. Here, Tammy has instructed Zig to tell a story about a rocket ship, which Zig has begun to tell. Also present in the room with Zig are three child users, named Wol 850, Xerc 852, and Yan 854. Zig is aware and knows certain information about the three child users. Yan is closest to Zig, and Zig has known him for seven months. Zig just met Xerc three minutes ago, and so far Zig only knows Xerc's name and face. Wol is a sibling of Yan who has some emotional development challenges of which Zig is aware. Wol has been known for about as long as Yan.

All this information is stored in clouds graphs maintained by the remote agent 810. More particularly, the higher-layer agent modules 210 organize the information as it is processed and generally store the information in the other knowledge base graphs 240. The higher-layer agent module 210 also uses the total available set of information to create and update a set of persistent motivations, which are stored in the motivation graph 230. The higher-layer agent modules 210 also create a specific story-telling motivation in response to the instruction received from Tammy.

At a certain point in time, Zig's motivation graph 230 (maintained at the remote agent 805) may have the following exemplary motivations shown as follows in Table 1:

TABLE I

| No. | Description |
|---|---|
| M1 | During recent minutes, Zig has been telling a story about a |
| | rocket ship. However, that story is currently in a |
| | paused/interrupted state, due to the gift received described in |
| | M2 below. Zig has a motivation to return and continue to |
| | tell the story. |
| M2 | During the last scene played, Zig perceived that Yan gave |
| | him an object that represented a toy, which interrupted Zig's |
| | rocket ship story. Zig has a motivation to respond to Yan's |
| | action. |
| M3 | Zig has a motivation to learn more about Xerc, who he just |
| | recently met. |
| M4 | About 5 minutes ago, Zig determined that his battery is |
| | getting low on charge. He has a motivation to charge his |
| | battery. |
| M5 | In the last 60 seconds, Zig has perceived that music has |
| | begun playing somewhere within audible distance of his |
| | microphones (e.g. from a nearby radio or television or |
| | computer, or sung by someone in another room). He is |
| | motivated to learn more about the music and interact with |
| | the music. |
| M6 | Because of Wol's emotional development challenges, Zig is |
| | motivated to calm Wol by performing calming intervention if |
| | Wol becomes disturbed. Because such intervention must be |
| | performed quickly, this would become a high priority |
| | motivation when necessitated. |

The set of six motivations described above is maintained through the combined action of all higher-layer agent modules 210 with access to Zig's motivation graph 230.

The scene planner module 260 makes use of all available information in the cloud graphs to translate each of the above six examples into one or more behavior records, which collectively form a scene specification record. For example, the scene planner module 260 may convert the motivations M1-M6 into the following behavior records (comprising steps and guards) shown in Table II:

TABLE II

| No. | Description |
|---|---|
| BR1 | Return to telling rocket ship story, but only if it still seems of |
| | interest to the users. |
| BR2 | Thank Yan for toy. Possibly follow up conversationally |
| | regarding the nature of the toy. |
| BR3 | Ask Xerc a question or questions to learn more about him. |
| BR4 | Move physically closer to battery charger, and ask for human |
| | help with plugging in charger once close enough. |
| BR5 | Interact with perceived music source, in some way involving |
| | dance (sometimes overt, sometimes understated foot tapping |
| | and head bobbing) and verbal discussion (if raised by users). |
| BR6 | Continue monitoring Wol's emotional state, and in rare case |
| | of apparent upset, attempt to help in appropriate way, at high |
| | priority. Offer this help in a way that is socially enjoyable |
| | for all users. |

In this exemplary case, the mapping from cognitive motivation set into behavioral intention set is one to one, but the scene planner module is free to rewrite the motivation set into any larger or smaller set of combined behavior intentions that most coherently and pleasingly represent the best conceived scene of appropriate duration, typically 10 to 100 seconds. Further, each behavior record comprises zero or more steps for carrying out the desired behavior which satisfies a motivation. And, each step may have zero or more guards. For example, behavior record BR4 may have the following steps and guards as shown in Table III:

TABLE III

| No. | Step | Guard |
|---|---|---|
| S1 | Determine path to charger | none |
| S2 | Locomotion along determined | Path must be unobstructed |
| | path to charger | |
| S3 | Say “I made it, plug me in!” | Must be in close proximity of |
| | | charger |

Similarly, the other behavior records contain steps and guards.

The scene specification is retrieved from the scene source graph 270 by the scene query module 310 of the scene execution module (SEM) 130. The channel access module 330 wires the necessary channels to process the behavior records. Then the behavior records are processed by the behavior processing module (BPM) 320. The BPM writes goals (physical, verbal, musical, etc.) to the goal graph 360, which are then read by the action module 720 of the character interaction module 150. The action module 720 then cause actuators to perform the step. For example, when S3 is executed, the BPM would write a speech-output goal to the goal graph, which would be read by the action module. The action module would then use a text-to-speech system to produce output audio that would be sent to the speaker actuator, thereby causing Zig's speaker actuator to say, “I made it, plug me in!” The action module is also responsible for instructing servo actuators in Zig's mouth to move in synchronization with the output audio, thus creating a convincing performance.

The BPM, as a software component, performs the six behaviors as cooperative tasks on a single thread. Preferably, it refreshes each behavior's processing at least five times each second. Typically, the exact order in which behaviors are asked to proceed is not significant to the total performance as they are being performed simultaneously. That is, Zig may ask Xerc a question (BR3), while at the same time walking towards the charger (S2 of BR4) and continuing to intend to eventually return to the rocket ship story. What is more significant is the fact that the local CPU sharing between behaviors is single-threaded, and thus they may operate free from low-level locking concerns on individual state variables.

However, the locking concerns that do matter are at the intentional level, where behaviors seek to avoid trampling upon each other. That is, they should seek to avoid producing output activity that will appear to be conflicting from end users' perspective. Knowing this, the scene planner module 260 generates behavior specifications that guard against conflict with each other using certain arbitrary variables in the working state graph 160. For example, a “topic” variable may be used to establish a sequential context for verbal interactions, and thus prevent the different verbally dependent behaviors from conflicting unnecessarily. The following pseudo-code illustrates such an example of using guards and steps employing the WorkingState.Topic parameter to resolve these issues:

Guard (WorkState.Topic = NONE)

Step(Mark(WorkState.Topic, ResumeRocketStory?”))

Guard (WorkState.Topic = “ResumeRocketStory?”)

Step(Launch([gest1 = Gesture(“Sheepish”), sayit1 =
Say(“Well, I would like to get back to the Apollo 999, if that
is alright with you folks?”), Mark(WorkState.Topic,
“GoRocketOrNo?”))

Guard (WorkState.Topic = “GoRocketOrNo?”, Heard(AFFIRMATIVE))

Step(Launch(sayitGO = Say(“OK, so the rocket was going
999,876 kilometers an hour...”),
Mark(SceneResults.RocketStoryInterest, “HIGH”),
Mark(WorkingState.Topic(“ROCKET,SPACE”)

Guard (WorkState.Topic = “GoRocketOrNo?”, Heard(NEGATIVE))

Step(Launch(sayitNO = Say(“Right, we have had enough spacey
silly talk for now.”),
Mark(SceneResults.RocketStoryInterest, “LOW”),
Mark(WorkingState.Topic, NONE))

The scene planner module 260 faces other difficulties in short term character performance related to the complexity of physical (and musical) performance and sensing in a dynamic environment, when multiple physical goals are active. They may similarly be resolved using an appropriate working state variable. The scene planner module is aware of the various steps being inserted into the scene specification record and thus may insert the appropriate guards when constructing the scene specification record.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for controlling the behavior of a social robotic character, the system comprising:
a scene planner module configured to assemble a scene specification record comprising one or more behavior records;
a scene execution module configured to receive the scene specification record and to process the scene specification record to generate an output; and
a character interaction module configured to receive the output and from the output cause the social robotic character to perform one or more behaviors specified by the one or more behavior records.

2. The system of claim 1 further comprising:
a remote agent adapted for containing the scene planner module is located at the remote agent; and
a local agent adapted for containing the scene planner module and a character interaction module are at the local agent.

3. The system of claim 2, wherein the local agent further comprises a scene planner module that requires less computational resource than the scene planner module at the remote agent.

4. The system of claim 2, wherein the remote agent is configured to provide scene specifications to two or more local agents.

5. The system of claim 1, wherein at least one behavior record comprises a step.

6. The system of claim 5, wherein the step has a guard.

7. The system of claim 6, wherein the guard is associated with the step by the scene planner module during assembly of the scene specification record.

8. The system of claim 7, wherein the scene planner module associates the guard with the step based on the presence of one or more other steps in the scene specification record.

9. The system of claim 7, wherein the scene planner module associates the guard with the step based information perceived by the character.

10. The system of claim 1 further comprising a character embodiment for embodying the social robotic character and performing the one or more behaviors specified by the one or more behavior records.

11. The system of claim 10, wherein the character embodiment is a physical robotic character.

12. The system of claim 10, wherein the character embodiment is a virtual robotic character.

13. The system of claim 10, wherein the scene planner module is configured to generate a new scene specification record every 10 to 100 seconds.

14. The system of claim 1, wherein the scene execution module processes each of the one or more behavior records in serial using for a limited amount of time.

15. The system of claim 14, wherein the scene execution module processes all of the one or more behavior records once in less than 200 milliseconds.

16. The system of claim 1, wherein the scene planner module is configured to access a database comprises templates of behavior records when assembling the scene specification record.

17. The system of claim 1, wherein the scene planner module is configured to access information related to the processing of previously generated scene specification record when assembling the scene specification record.

18. A method for controlling the behavior of a social robotic character, the method comprising the steps of:
assembling a scene specification record comprising one or more behavior records;
processing the scene specification record to generate an output; and
causing the social robotic character to perform one or more behaviors specified by the one or more behavior records based on the output.

19. A non-transitory computer readable storage medium having stored thereon machine readable instructions for controlling the behavior of a social robotic character, the non-transitory computer readable storage medium comprising:
instructions for assembling a scene specification record comprising one or more behavior records;
instructions for processing the scene specification record to generate an output; and
instructions for causing the social robotic character to perform one or more behaviors specified by the one or more behavior records based on the output.
